(19) United States
(12) Patent Application Publication
(10) Pub. No.: US 2020/0001202 A1
(43) Pub. Date: Jan. 2, 2020

(54) OIL EXTRACTION APPARATUS WITH COLLAPSIBLE BAG

(71) Applicant: Steven Franklin Baugh, Broomfield, CO (US)

(72) Inventor: Steven Franklin Baugh, Broomfield, CO (US)

(21) Appl. No.: 16/025,404

(22) Filed: Jul. 2, 2018

(51) Int. Cl. B01D 11/02; C11B 1/10

(52) U.S. Cl. CPC B01D 11/0219; C11B 1/104; C11B 1/102

(57) ABSTRACT

An extractor to extract oil from a biological plant or portion thereof. A rigid container is provided, which has apertures at an upper extremity and a lower extremity. A collapsible bag is placed within the rigid container, the bag having an aperture at an upper extremity for accepting a biological plant and a solvent, and a second aperture at a lower extremity. A vacuum pump is operatively connected to the lower extremity of the collapsible bag within the rigid container. When a vacuum is applied to the bag within the rigid container, the bag collapses, squeezing the contents therein, so oil is extracted from the plant and the solvent is removed. The bag can be removable or the entire rigid container unit and its contents can be lifted out of the apparatus. The low-weight, squeeze dried residue in the collapsed bag facilitates material transfers and later disposal. This design also allows the rigid container to be less sturdy, as it does not take the force of the vacuum, reducing cost in construction of the rigid container assembly or assemblies.

### FIELD OF THE INVENTION

The present application relates to oil extraction apparatuses and, more particularly, to an apparatus used to extract oil from a biological plant without the use of a press, wherein a collapsible bag is provided to contain and process the plant during extraction operations.

### BACKGROUND OF THE INVENTION

Cannabis extract has wide-ranging beneficial effects on a number of medical conditions. Chronic pain has been shown to be controlled by use of cannabis. Use of a topical application of cannabis extract in dermal penetrating cream has been effective in relieving chronic pain conditions of arthritis and tendonitis. The use of a topical application of the extract in a penetrating cream formulation allows the medication to directly affect the local receptor sites. This direct application at the affected sites allows rapid modulation of the pain and inflammation of these chronic conditions.

A specific pain condition that has been effectively treated by the use of cannabis extract is fibromyalgia. This chronic debilitating condition involves local pain at specific sites on the body. The use of this extract allows stimulation of the CB2 receptor sites in the local pain areas as well as stimulation of the CB1pns receptors. This disease, which is a combination of autoimmune and inflammatory conditions, responds extremely well to topical applications of cannabis extract.

Autoimmune diseases also seem to respond very well to the application of cannabis extract. This is because of the action on the CB2 receptors which are located on several different cells lines in the immune system. Through the inhibition of TCF-alpha, cannabis has a beneficial effect on patients with multiple sclerosis and lupus. These severe and chronic autoimmune diseases have been shown in several studies to respond to smoked cannabis. Topical application is effective without the psychoactive side effects. By selective stimulation of the CB2 receptors the immune modulation effects of the cannabis extract have a beneficial effect on multiple sclerosis and lupus without the central nervous system effects.

Nausea and vomiting that are unresponsive to other medications have been shown to be helped through the use of cannabis. The use of cannabis extract has a modulating effect on nausea and vomiting without the psychoactive properties that smoking the Cannabis plant can cause in a mammal. This has been shown to be especially useful in helping with the side effects of chemotherapy. Additionally animal studies show an increase in hunger and feeding behavior through the action of the CB2 receptors.

Applying topical cannabis extract has a positive effect on the healing of psoriasis lesions. The cannabis plant contains resinous trichrome structures which are the source of cannabinoids, such as tetrahydrocannabinol (THC) and cannabidiol (CBD). Devices and methods of using cannabis ideally seek to separate the trichromes from the accompanying plant material. However, the plant material contains terpenoids and flavonoids, which provide desirable odor and flavor as well as a beneficial synergistic entourage effect. The traditional method of using cannabis has been to smoke the leaves and buds of the plant, but the combustion of the whole plant material introduces noxious components to the body in addition to desirable cannabinoids, terpenoids, and flavonoids.

To maximize the production and preservation of the cannabinoid, terpenoid, and flavonoid components, while minimizing the amount of plant material, a number of extraction methods have been used. Rosin refers to a resinous extract product created from an extraction process applied to cannabis starting material that utilizes a combination of heat and pressure. With cannabis, the heat and pressure method can be used either with flowers or less desirable leaves of the cannabis plant and can also be used to clean up water hash and sifted kief into a full-melt hash oil of high purity. The result is a translucent, sappy, and sometimes clear and brittle glass-like product. If executed correctly, rosin can rival or surpass the flavor, potency, quality, and yield of other solvent-based extraction products with increased safety and ease. One reason for rosin's popularity is that it is a solvent-less technique, so the process does not require the use of volatile hydrocarbon solvents. Instead, rosin uses a mechanical process involving heat and pressure to extract the desired components from the plant.

Solvent extraction systems utilize light hydrocarbons such as butane and/or propane as solvents. Often, these complex and mechanical systems require a lengthy purge to safely remove most of the residual solvents from the final product. Accomplishing an oil extraction process from plants, such as hemp, without the need for a separate press operation to remove excess solvent would represent a distinct advance in the art over conventional processes.

### DESCRIPTION OF RELATED ART

U.S. Pat. No. 5,516,923 for EXTRACTING OIL FROM OIL BEARING PLANT PARTS issued to Hebert, et al. on May 14, 1996 describes a process for extracting oil from an oil bearing plant material with the use of a solvent suitable for dissolving the oil in the plant material. Grounded plant material is deposited into a reactor vessel, and vacuum is created in the reactor vessel. Liquid solvent is introduced into the reactor vessel and allowed to contact the plant material for a time sufficient to dissolve oil from the plant material, while the temperature in the reactor vessel is maintained at a level which prevents denaturing of constituent components of the plant oil and the plant material. Additional solvent vapors are introduced into the bottom of the reactor to cause mixing of the plant material and the solvent and separate fine particulate matter from heavier particles. Pressurized heated solvent vapors are introduced into the top of the reactor vessel while the liquid solvent and oil combination is being removed from the bottom of the reactor vessel through filters. To prevent clogging of filters in the bottom of the reactor vessel pressurized solvent vapors are forced through the filters into the bottom of the reactor vessel. The solvent and oil combination is transferred into a separator vessel, wherein the solvent is vaporized and removed for recycling, while the oil is removed into a holding tank.

U.S. Pat. No. 5,281,732 for SOLVENT EXTRACTION OF OIL FROM OIL-BEARING MATERIALS issued to Franke on Jan. 25, 1994 describes a low temperature process for extracting oil from oil-bearing materials by extracting the oil-bearing material in an extraction zone with a normally gaseous solvent selected from propane, butane, and mixtures thereof. As the resulting solvent/oil mixture is passed through the bed of extracted oil-bearing material, from the extraction zone, and to a separation zone, it is done so under conditions that will maintain the solvent in liquid form.

U.S. Pat. No. 9,649,575 for ORGANIC OIL EXTRACTION DEVICE issued to Hopkins, et al. on May 16, 2017 describes an organic oil extraction device comprising: one or more connection ports; a first chamber; a second chamber; a heat source; one or more vacuum pumps; and a burner assembly. The one or more connection ports may receive one or more sources of pressurized butane liquid. The first chamber may receive an organic matter and butane liquid from the one or more sources of pressurized butane liquid. The butane liquid may enter the first chamber, passes through the organic matter, and extracts an organic oil from the organic matter to create a butane liquid and organic extract. The butane liquid and organic extract may enter and accumulate in the second chamber. The heat source may heat the butane liquid and organic extract such that the butane liquid is converted into a butane gas. The one or more vacuum pumps may extract the butane gas from the second chamber, and the burner assembly may burn off the extracted butane gas.

U.S. Pat. No. 8,092,752 for APPARATUS AND METHOD FOR OIL AND FAT EXTRACTION issued to Davis on Jan. 10, 2012 describes an apparatus and method for extracting oils and fats from oil-bearing substances without using degrading temperatures. The apparatus may comprise an extraction chamber containing an oil-bearing substance, an oil-collecting chamber, a recovery pump, a first jacket adjacent at least a portion of the extraction chamber, and a second jacket adjacent at least a portion of the oil-collecting chamber. The method involves heating a solvent and reducing pressure to facilitate a low-temperature vacuum boil; delivering the heated solvent into the extraction chamber configured to facilitate the low-temperature vacuum boil of the solvent within the extraction chamber; pumping the solvent in vapor form out of the extraction chamber with the recovery pump; delivering the oil and fat extracted in the extraction chamber to the oil-collecting chamber; pumping solvent in vapor form out of the oil-collecting chamber with the recovery pump; and delivering the solvent received by the recovery pump to the first and second jackets to provide heat to the chambers.

### SUMMARY OF THE INVENTION

In accordance with the present invention, there is provided an extractor for use with liquid solvents for extracting oil from a biological plant or portion thereof. A rigid container is provided, which has apertures at an upper extremity and a lower extremity. A vacuum pump is operatively connected to the a collapsible bag placed within the rigid container, the bag having an aperture at an upper extremity for accepting a biological plant and a solvent, and a second aperture at a lower extremity. When a vacuum is applied to the bag within the rigid container, the bag collapses, squeezing the contents therein, so oil is extracted from the plant and the solvent is removed. The bag can be removable from the rigid container unit and its contents can be lifted out of the apparatus. The low-weight, squeeze dried residue in the collapsed bag facilitates material transfers and later disposal.

It is therefore an object of the invention to provide a plant oil extraction system that facilitates the extraction of oil from plants, the recovery of process solvent, and the disposal of processed plants.

It is also an object of the invention to increase efficiency of plant processing without using a press to recover solvent.

It is another object of the invention to provide a mechanism to lift and handle processed plant material easily.

It is a further object of the invention to provide a mechanism to load plant material, extract oil therefrom, and squeeze and dispose of the plant material in a single, light-weight, removable bag.

These and other objects and advantages of the present invention are more readily apparent with reference to the following detailed description and the accompanying drawings.

### BRIEF DESCRIPTION OF THE DRAWINGS

A complete understanding of the present invention may be obtained by reference to the accompanying drawings, when considered in conjunction with the subsequent detailed description, in which:

FIG. 1 is a front, schematic view of the extractor system in accordance with the present invention;

FIG. 2 is a front, perspective view of the extractor system shown in FIG. 1 with a collapsible bag being inserted therein; and

FIG. 3 is a cross-sectional view of the extractor system shown in FIGS. 1 and 2 with a collapsible bag in situ.

Like reference numerals refer to like parts throughout the several views of the drawings.

### DETAILED DESCRIPTION OF EMBODIMENTS

Although the following detailed description contains specific details for the purposes of illustration, those of ordinary skill in the art will appreciate that variations and alterations to the following details are within the scope of the invention. Accordingly, the exemplary embodiments of the invention described below are set forth without any loss of generality to, and without imposing limitations upon, the claimed invention.

One or more different inventions may be described in the present application. Further, for one or more of the invention(s) described herein, numerous embodiments are described in this patent application for illustrative purposes only.

The described embodiments are not intended to be limiting in any sense. One or more of the inventions may be widely applicable to numerous embodiments, as is readily apparent from the disclosure. These embodiments are described in sufficient detail to enable those skilled in the art to practice one or more of the inventions, and it is to be understood that other embodiments may be utilized and that structural, logical, software, electrical and other changes may be made without departing from the scope of the one or more of the inventions. Accordingly, those skilled in the art will recognize that the one or more of the inventions may be practiced with various modifications and alterations.

Particular features of one or more of the inventions may be described with reference to one or more particular embodiments or figures that form a part of the present disclosure, and in which are shown, by way of illustration, specific embodiments of one or more of the inventions. It should be understood, however, that such features are not limited to usage in the one or more particular embodiments or figures with reference to which they are described. The present disclosure is neither a literal description of all embodiments of one or more of the inventions nor a listing of features of one or more of the inventions that must be present in all embodiments.

A description of an embodiment with several components in concert with each other does not imply that all such components are required. To the contrary, a variety of optional components are described to illustrate the wide variety of possible embodiments of one or more of the inventions.

Moreover, the illustration of a process by its depiction in a drawing does not imply that the illustrated process is exclusive of other variations and modifications thereto, does not imply that the illustrated process or any of its steps are necessary to one or more of the inventions, and does not imply that the illustrated process is preferred.

When a single device or article is described, it will be readily apparent that more than one device/article (whether or not they cooperate) may be used in place of a single device/article. Similarly, where more than one device or article is described (whether or not they cooperate), it will be readily apparent that a single device/article may be used in place of the more than one device or article.

The functionality and/or the features of a device may be alternatively embodied by one or more other devices that are not explicitly described as having such functionality/features. Thus, other embodiments of one or more of the inventions need not include the device itself.

The invention is an extractor for use with liquid solvents for extracting oil from a biological plant or portion thereof. A rigid container has apertures at an upper extremity and lower extremity. A vacuum pump is operatively connected to the rigid container and a collapsible bag therein.

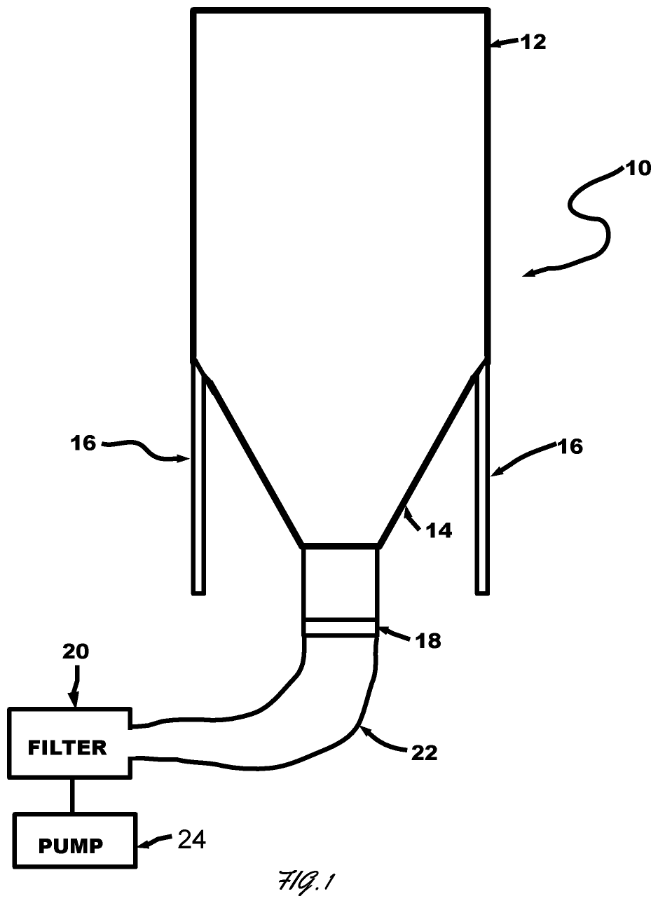

Referring now to FIG. 1, there is shown a front, schematic view of the extractor system 10 in accordance with the present invention. A rigid container 12 is the main component of extractor system 10. Rigid container 12 is aluminum and cylindrical in the preferred embodiment, but other materials and shapes can be used without departing from the scope of the invention. Extending from the lowermost portion of rigid container 12 is a tapered portion 14 for facilitating collection of material therein, not shown. Rigid container 12 is supported by a suitable housing or posts 16, well known to those of skill in the art.

At the lowermost extremity of rigid container 12 is an O-ring gasket 18 to which is operatively connected a filter 20, such as Model No. WFPF13003B manufactured by the DuPont Company, connected by a flexible hose 22. Connected to filter 20 by suitable means is an electric vacuum pump 24, such as Supervac™ 11.3 CFM manufactured by Across International, LLC. Vacuum pump 24 preferably operates to draw a 15 psi vacuum, but other values can be used depending on the size of the rigid container 12 and the speed at which extraction operations are to be performed. A reservoir, not shown, can be placed between filter 20 and vacuum pump 24, if desired, to collect solvent extracted from rigid container 12.

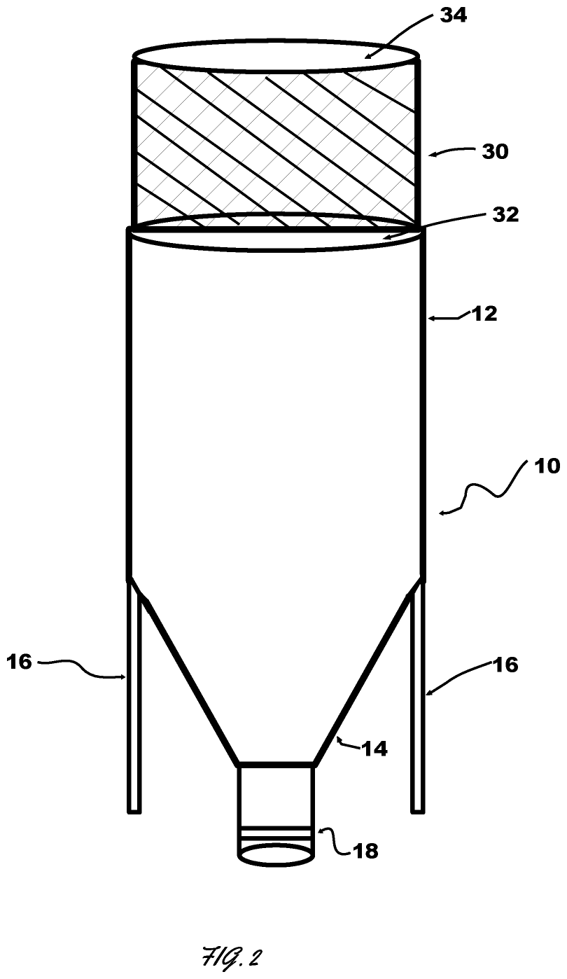

Referring now to FIG. 2 there is shown a front, perspective view of the extractor system 10 with a collapsible bag 30 being inserted in an uppermost aperture 32 of rigid container 12. Collapsible bag 30 is preferably constructed of polyurethane material, but any chemically compatible material can be used. Collapsible bag 30, preferably made of polyurethane material, has an aperture 34 at the uppermost extremity thereof for inserting plant material, such as hemp, and solvent, such as ethanol and/or isopropyl alcohol liquid, not shown, thereinto once bag 30 is positioned and completely seated in rigid container 12.

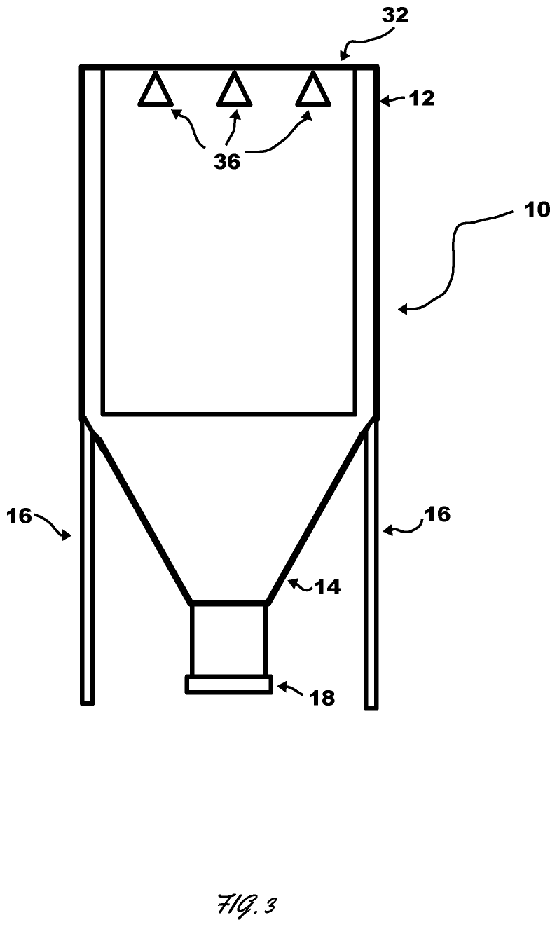

Referring now to FIG. 3, there is shown a cross-sectional view of the extractor system 10 with collapsible bag 30 in situ. Retainer clips 36 attached to rigid container 12 hold the uppermost extremity of bag 30 in position relative to aperture 34 of rigid container 12.

In operation, collapsible bag 30 is first placed in uppermost aperture 32 of rigid container 12 and secured thereto by retainer clips 36. Plant material and liquid solvent, not shown, are then inserted into aperture 34 of collapsible bag 30. Vacuum pump 24 is then activated to extract the solvent in bag 30, which collapses in the resulting vacuum created in rigid container 12. The liquid solvent is filtered prior to being introduced into a reservoir, not shown. Bag 30 and now lower-weight, squeeze dried residue, not shown, is lifted out of rigid container 12 and the contents discarded. Another collapsible bag 30 can then be inserted in rigid container 12 and secured by retainer clips 36 for the process to be repeated.

Alternatively, once vacuum pump 24 is activated to extract the solvent in bag 30, completing the cycle, the entire rigid container 12 may be removed and replaced with a rigid container having a new collapsible bag already filled with hemp and/or solvent. This can accelerate the process considerably, at the expense of lifting a heavier rigid container and its contents into operational place.

It can be seen that the inventive system and apparatus represents an improvement in solvent recovery and plant processing efficiency over conventional extraction presses.

Since other modifications and changes varied to fit particular operating requirements and environments will be apparent to those skilled in the art, the invention is not considered limited to the example chosen for purposes of disclosure and covers all changes and modifications which do not constitute departures from the true spirit and scope of this invention.

Having thus described the invention, what is desired to be protected by Letters Patent is presented in the subsequently appended claims.

What is claimed is:

1. An extractor for use with liquid solvents for extracting oil from a biological plant or portion thereof, the extractor comprising:
a) a rigid container having a first aperture at an upper extremity thereof and a second aperture at a lower extremity thereof;
b) a vacuum pump having a vacuum side operatively connected to the rigid container for creating a vacuum therein to evacuate air and material; and
c) a collapsible bag having a first aperture at an upper extremity thereof for accepting a biological plant or portion thereof and a solvent, and a second aperture at a lower extremity thereof, the collapsible bag being place in the rigid container.

2. The extractor for use with liquid solvents for extracting oil from a biological plant or portion thereof in accordance with claim 1, wherein the collapsible bag is removable.

3. The extractor for use with liquid solvents for extracting oil from a biological plant or portion thereof in accordance with claim 1, wherein the vacuum pump is electrically powered.

4. The extractor for use with liquid solvents for extracting oil from a biological plant or portion thereof in accordance with claim 1, wherein the vacuum pump is capable of drawing 15 psi from the rigid container.

5. The extractor for use with liquid solvents for extracting oil from a biological plant or portion thereof in accordance with claim 1, wherein the rigid container is cylindrical.

6. The extractor for use with liquid solvents for extracting oil from a biological plant or portion thereof in accordance with claim 1, further comprising a filter proximate the vacuum pump.

7. The extractor for use with liquid solvents for extracting oil from a biological plant or portion thereof in accordance with claim 1, further comprising a reservoir for collecting solvent from the rigid container.

8. The extractor for use with liquid solvents for extracting oil from a biological plant or portion thereof in accordance with claim 1, wherein the rigid container and its contents can be removed from the apparatus and replaced with another rigid container and its contents.

9. The extractor for use with liquid solvents for extracting oil from a biological plant or portion thereof in accordance with claim 1, further comprising at least one retainer clip attached to the rigid container for retaining the collapsible bag in operative position.

10. The extractor for use with liquid solvents for extracting oil from a biological plant or portion thereof in accordance with claim 1, wherein the collapsible bag comprises polyurethane.

11. An extractor for use with liquid solvents for extracting oil from a biological plant or portion thereof, the extractor comprising:
a) a rigid container having a first aperture at an upper extremity thereof and a second aperture at a lower extremity thereof;
b) means operatively connected to the rigid container for creating a vacuum therein to evacuate air and material; and
c) a collapsible bag having a first aperture at an upper extremity thereof for accepting a biological plant or portion thereof and a solvent, and a second aperture at a lower extremity thereof, the collapsible bag being place in the rigid container.

12. The extractor for use with liquid solvents for extracting oil from a biological plant or portion thereof in accordance with claim 11, wherein the collapsible bag is removable.

13. The extractor for use with liquid solvents for extracting oil from a biological plant or portion thereof in accordance with claim 11, wherein the means for creating a vacuum is electrically powered.

14. The extractor for use with liquid solvents for extracting oil from a biological plant or portion thereof in accordance with claim 11, wherein the means for creating a vacuum is capable of drawing 15 psi from the rigid container.

15. The extractor for use with liquid solvents for extracting oil from a biological plant or portion thereof in accordance with claim 11, wherein the rigid container is cylindrical.

15. The extractor for use with liquid solvents for extracting oil from a biological plant or portion thereof in accordance with claim 11, further comprising a filter proximate the means for creating a vacuum.

17. The extractor for use with liquid solvents for extracting oil from a biological plant or portion thereof in accordance with claim 11, further comprising a reservoir for collecting solvent from the rigid container.

18. The extractor for use with liquid solvents for extracting oil from a biological plant or portion thereof in accordance with claim 11, wherein the rigid container and its contents can be removed from the apparatus and replaced with another rigid container and its contents.

19. The extractor for use with liquid solvents for extracting oil from a biological plant or portion thereof in accordance with claim 11, further comprising at least one retainer clip attached to the rigid container for retaining the collapsible bag in operative position.

20. The extractor for use with liquid solvents for extracting oil from a biological plant or portion thereof in accordance with claim 11, wherein the collapsible bag comprises polyurethane.
